(19) United States
(12) Patent Application Publication
(10) Pub. No.: US 2016/0060134 A1
(43) Pub. Date: Mar. 3, 2016

(54) WATER CONTAINER FILLER DEVICE

(71) Applicants: Robert William LACKEY, Hickory, NC (US); Robert Charles BECKMANN, Vale, NC (US); Glenn Fletcher CUEMAN, Denver, NC (US)

(72) Inventors: Robert William LACKEY, Hickory, NC (US); Robert Charles BECKMANN, Vale, NC (US); Glenn Fletcher CUEMAN, Denver, NC (US)

(73) Assignee: PROTECT PLUS LLC, Hickory, NC (US)

(21) Appl. No.: 14/837,072

(22) Filed: Aug. 27, 2015

Related U.S. Application Data
(60) Provisional application No. 62/042,455, filed on Aug. 27, 2014.

(51) Int. Cl. C02F 1/00; E03C 1/084

(52) U.S. Cl. CPC C02F 1/003; E03C 1/084; C02F 2307/10

(57) ABSTRACT

The present invention provides methods and systems for a water container filler that includes a body, an opening within the body that is designed to allow a stream of water to flow into the body through the opening, a cavity within the body, at least one wing that is pivotally connected to the body, and an outlet for allowing the water to flow out of the body.

### CROSS REFERENCE TO RELATED PATENT APPLICATION

The present non-provisional patent/patent applications claims priority to U.S. Provisional Patent Ser. No. 62/042,455 filed Aug. 27, 2014 and entitled “WATER CONTAINER FILLER,” the contents of which are incorporated by reference herein.

### FIELD OF THE INVENTION

The present invention relates generally to a water container filler device for filtering water and more generally relates to a water container filler device that is placed in a stream of water above a container, such as a drinking glass, bottle, or the like that may filter water prior to entering the container.

### BACKGROUND OF THE INVENTION

Water is a basic necessity to sustain all life. Every living thing on the planet, animal and plant, needs water to survive. As such, the need for clean, pure water will never decrease. In fact, as populations grow, the need for clean, pure water will only increase. Recently, society has begun to focus more on the purity of water for both drinking and other applications. The recent success of the bottled water industry conclusively shows that the desire for pure water is increasing within the population. Pure water is bottled by a multitude of manufacturers and is sold in many places throughout the world. Demand for pure bottled water is increasing and shows no signs of waning.

It is widely accepted that drinking water as opposed to other liquids, even those based on water, has many health benefits. The medical community in the United States periodically issues statements that indicate the average person does not drink enough water. Unlike soda, milk, and other beverages, water is available to most people simply by turning on a faucet. Despite this wide availability of potable water, most people simply do not drink enough.

Typically, a local utility company provides potable water to people. The utility company is generally responsible for ensuring that the water provided to homes and businesses is clean, pure, and free from harmful organisms. Indeed, many people rely solely on the public water systems to guarantee that the water flowing into their homes and businesses is fit for consumption. Typically, the municipal body responsible for providing water to the populace will have various treatment and purification procedures to help ensure the quality of the water provided to consumers. These systems can include large, industrial scale filters, treatment tanks, and other water processing devices. Unfortunately, sometimes these systems can break down, or these systems can miss a contaminant leaving the treated water with various forms of impurities.

Since water is such a vital part of people's everyday needs, the desire for clean, pure water will continue to grow, and will likely never diminish. Most municipal treatment facilities do an adequate job in cleaning and purifying water, however, there is concern that the municipal systems responsible for providing clean, pure water are simply overworked. Filtration of water on such a large scale can sometimes lead to water that contains particulate filtrate material left over from where the water was originally filtered. Moreover, some of the treatment methods and additive chemicals used in the cleaning and purifying of water can leave the water containing undesirable contaminants, odors, or tastes.

Municipal water treatment systems typically focus on removing various contaminants from water in order to provide clean, potable water for human consumption. Large scale purification of water is designed to reduce or eliminate the concentration of particulate matter including suspended particles, parasites, bacteria, algae, viruses, and fungi. Also, the municipal treatment facilities have apparatuses and methods to remove a wide range of dissolved and particulate material picked up by water from the surfaces the water may have made contact with after falling as rain and flowing to the treatment facility.

In the United States, the government typically sets the standards for drinking water quality. The government requires that various standards designed to ensure the drinking water is safe for consumption are met. In other countries around the world, however, the standards and thresholds for certain contaminants are not as stringent. Thus the warning of “don't drink the water,” in various places around the world. Unfortunately, because many countries do not require the same standards for their water that the United States requires, many of the world's countries have water that contains harmful organisms or other impurities.

According to a 2007 World Health Organization report, 1.1 billion people lack access to an improved drinking water supply. The WHO estimates that 88% of the 4 billion annual cases of diarrheal disease are attributed to unsafe water and inadequate sanitation and hygiene. Further, 1.8 million people die from diarrheal diseases each year. The WHO further estimates that 94% of these diarrheal cases are preventable through modifications to the environment, including access to safe water. The WHO concludes that a few simple techniques for treating water at home, such as chlorination, filters, and solar disinfection, combined with storing it in safe containers could save a huge number of lives each year.

In most cases, it is not possible to tell whether water is of an appropriate quality by visual examination. If water has a cloudy appearance or there are visible particles present, then the water is most likely unsafe to drink. However, many dangerous contaminants are simply too small to be visible to the naked eye. It is impossible to know that the water is clean, pure, and fit to drink simply by looking at it. Thus, some simple procedures such as boiling or the use of a household activated carbon filter have been devised in an attempt to clean and purify water for drinking. Unfortunately, these simple steps are not sufficient for treating all the possible contaminants that may be present in water from an unknown source. Even natural spring water, which in the nineteenth century was considered safe for all practical purposes, must now be tested before determining what kind of treatment, if any, is needed. A chemical analysis of water, while expensive, is the only way to obtain the information necessary for deciding on the appropriate method of purification.

Thus, a need exists for a simple, easy to use device that will ensure that a persons' drinking water is clean, pure, does not contain harmful contaminants, and tastes good. More specifically, a need exists for a water filter device capable of residential use that will allow users to be assured that any contaminants left in water after the municipal treatment of the water are removed prior to drinking.

The present invention is an easy to use, transportable water container filler that may filter water from a municipal drinking water source and into a drinking glass, water bottle, or the like.

### BRIEF SUMMARY OF THE INVENTION

The present invention discloses a water container filler device that includes a body, an opening within the body that is designed to allow a liquid, such as water, to flow into the body through the opening, a cavity within the body, and an outlet for allowing the water to flow out of the body.

According to another embodiment of the present invention, the water container filler device includes a body with a top portion and a bottom portion that are selectively secured to one another.

According to yet another embodiment of the present invention, the water container filler device includes a filter retainer for receiving a filter media.

According to yet another embodiment of the present invention, the water container filler device includes a mouth piece engaged to the opening in the body.

According to yet another embodiment of the present invention, the water container filler device includes at least two wings pivotally engaged to the body.

According to yet another embodiment of the present invention, the water container filler device includes at least three wings pivotally engaged to the body.

According to yet another embodiment of the present invention, the water container filler device includes at least one hinge engaged to an outer surface of the body and at least one wing pivotally connected to the at least one hinge.

According to yet another embodiment of the present invention, the water container filler device includes the opening and the outlet being aligned in the axial direction.

According to yet another embodiment of the present invention, the water container filler device includes a body that has a top portion and a bottom portion that are selectively secured to one another, an opening within the body that is designed to allow water to flow into the body through the opening, a cavity within the body formed between the top portion and the bottom portion, a mouth engaged to the top portion, and an outlet for allowing the water to flow out of the body.

According to yet another embodiment of the present invention, the water container filler device includes a filter member disposed within the cavity.

According to yet another embodiment of the present invention, the water container filler device includes a notch on the underside of the at least one wing and a catch positioned on an external side of the body for receiving the notch.

According to yet another embodiment of the present invention, a method for filtering water that includes providing a device comprising a body, an opening within the body, a cavity within the body, at least one wing that is engaged to the body, and an outlet for allowing the water to flow out of the body. The device is placed over a container, and water is allowed to enter the opening and flow through the device and into the container.

### BRIEF DESCRIPTION OF THE DRAWINGS

The present invention is illustrated and described herein with reference to the various drawings, in which like reference numbers denote like method steps and/or system components, respectively, and in which:

FIG. 1 is a perspective view of the water container filler;

FIG. 2 is an exploded view of the water container filler;

FIG. 3 is another exploded view of the water container filler;

FIG. 4 is an alternative embodiment of the water container filler;

FIG. 5 is a perspective view of the water container filler in use; and

FIG. 6 is a bottom view of an alternative embodiment of the top portion of the device

### DETAILED DESCRIPTION OF THE INVENTION

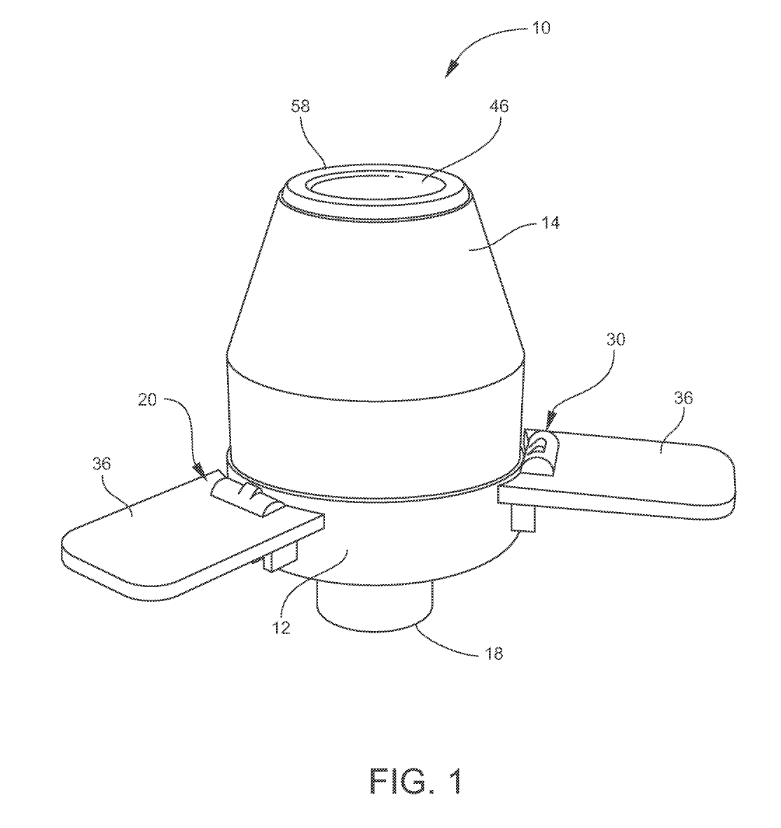

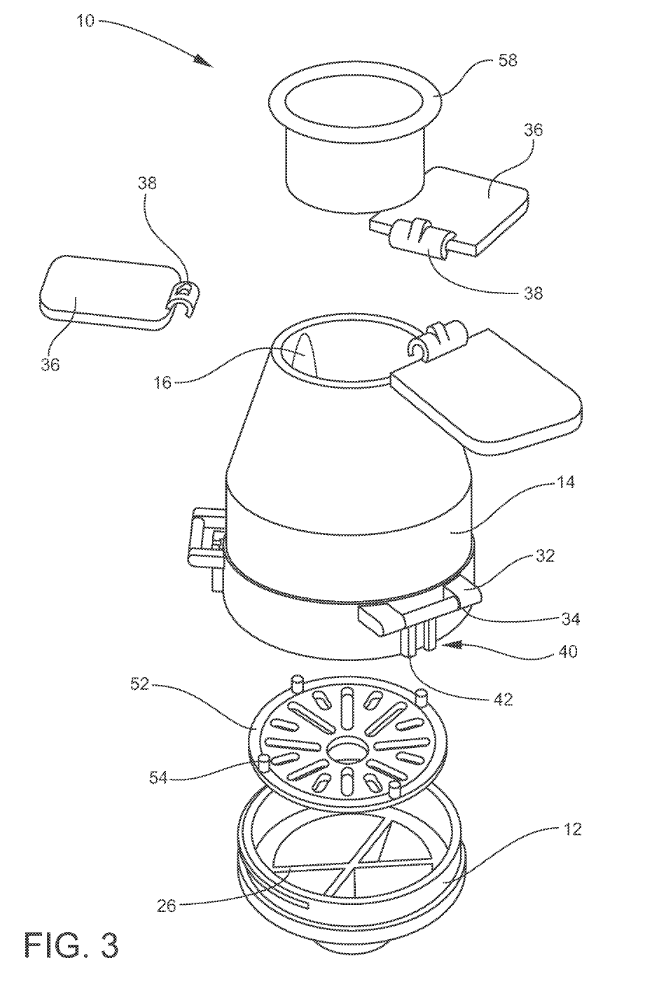

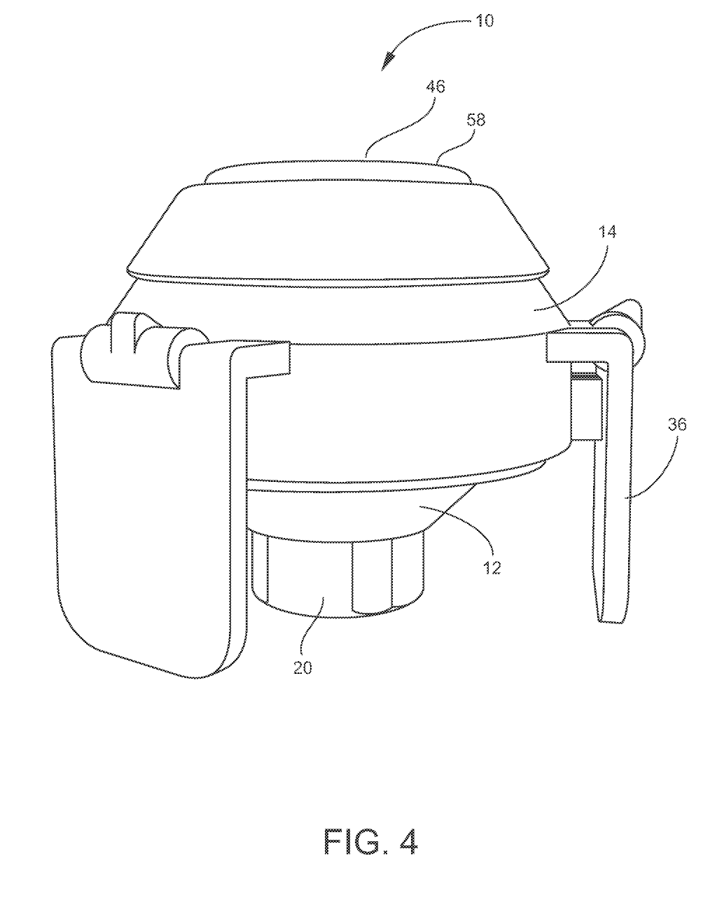

Referring now specifically to the drawings, a water container filler device 10 is illustrated in FIGS. 1-5 and is shown generally at reference numeral 10. The water container filler device 10 includes a body that has a bottom portion 12 and a top portion 14 and an interior surface and an exterior surface. The bottom portion 12 and the top portion 14 are selectively secured to one another forming a cavity 16 therein. Optionally, a filter media or filter member 50 may be disposed within the cavity 16 between the bottom portion 12 and the top portion 14. The top portion 14 is internally threaded for receiving corresponding external threads of the bottom portion 12 for forming a selectively secured arrangement.

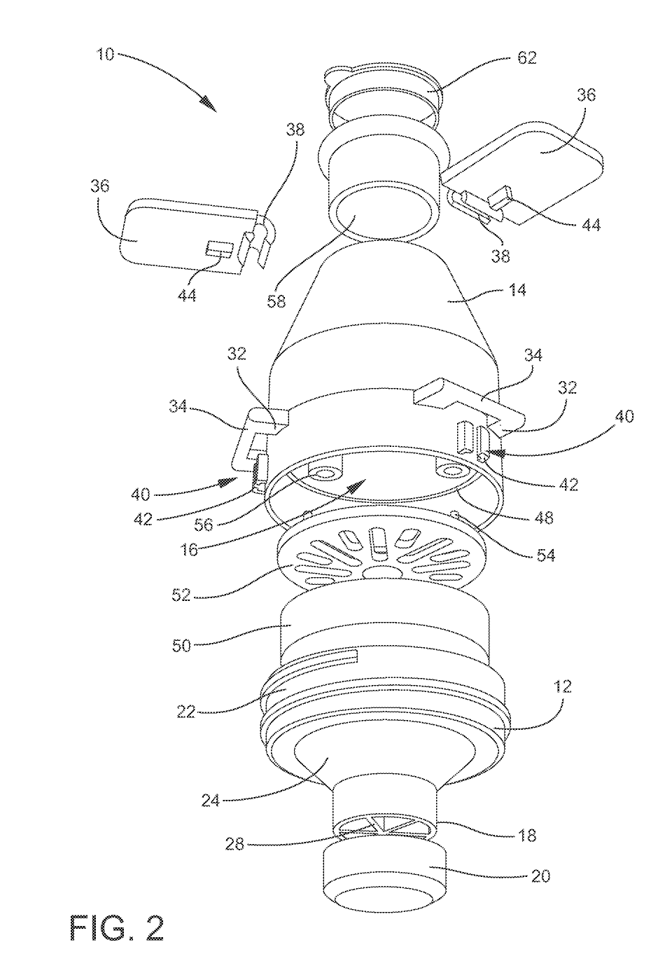

The bottom portion 12 contains an outlet 18 that may be centrally located and disposed on the exterior of the bottom portion 12. As shown in the figures, the bottom portion 12 channels the water to the outlet 18 much like a funnel. As shown in FIG. 2, the outlet 18 preferably is a cylindrical opening that extends downwards from the exterior of the bottom portion 12. The outlet 18 may also contain a cap 20 that fits overtop the outlet 18. The bottom portion 12 contains an annular ring 22 that is externally threaded and a frustoconical portion 24 slopping inwards from the annular ring 22. The frustoconical portion 24 decreases in diameter from the annular ring 22 to the outlet 18. The frustoconical portion 24 channels the water into a downwardly extending outlet 18. The frustoconical portion 24 may contain a plurality of ribs 26 that extend from an outer edge of the frustoconical portion 24 and meet at a central point. Likewise, the outlet 18 may contain a plurality of ribs 28 that extend from an outer edge of the outlet 18 and meet at a central point.

The exterior of the top portion 14 may contain at least one hinge 30. As illustrated, the exterior of the upper portion 14 may contain three hinges 30 that extend outward from the top portion 14. The hinge 30 may consist of two spaced-apart outward protrusions 32 that are joined by a rod 34 spanning between the two spaced-apart outward protrusions 32. The rod 34 is generally curved for receiving a wing 36 that is pivotally connected to the hinge 30. The hinge 30 allows the wing 36 to extend outward from the body of the device 10 for placement over a container and allows the wing 36 to fold downwards and adjacent the body of the device 10 when not in use.

The wing 36 contains a c-shaped portion 38 that extends outward from one side of the wings 36. The c-shaped portion 38 is rotationally engaged to the generally cylindrical portion of the rod 34 of the hinge 30 for pivotally engaging the wing 36 to the hinge 30. The wing 36 contains two opposed sides, a top side, and a bottom side and may be any shape or form. As illustrated, the wing 36 may be generally square or generally rectangular. A stop 64 is disposed on the external side of the c-shaped portion 38 for preventing the wing 36 from rotating past the substantially horizontal plane.

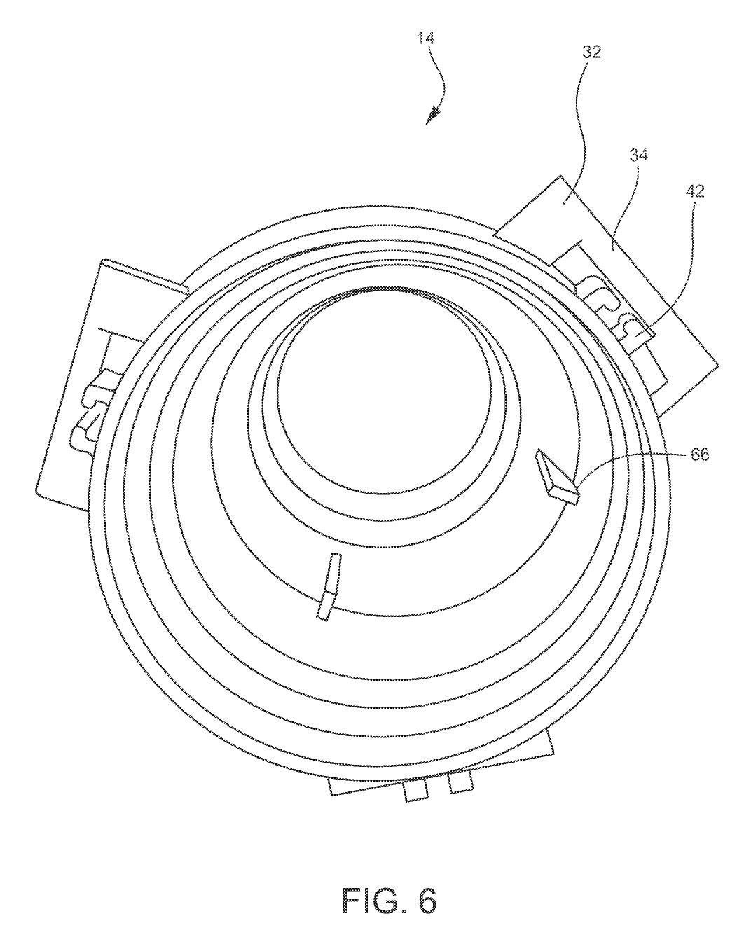

A catch 40 is disposed on the exterior of the top portion 14. The catch 40 is disposed below the hinge 30 and may consist of two generally parallel nobs 42 that are generally t-shaped. As illustrated, the catch 40 may be generally t-shaped. The catch 40 receives a notch 44 disposed on the underside of the wing 36 for receiving and selectively securing the notch 44 by friction fit and retaining the wings 36 in the downward or stored position. Specifically, the top portion of the t-shaped catch 40 receives the top portion of the t-shaped notch 44 for receiving and selectively securing the notch 44 by friction fit and selectively retaining the wings 36 in the downward or stored position. In another alternative embodiment as illustrated in FIG. 6, the notch 42 may be generally L-shaped with the horizontal portions of the “L” directed towards each other for receiving the notch 44.

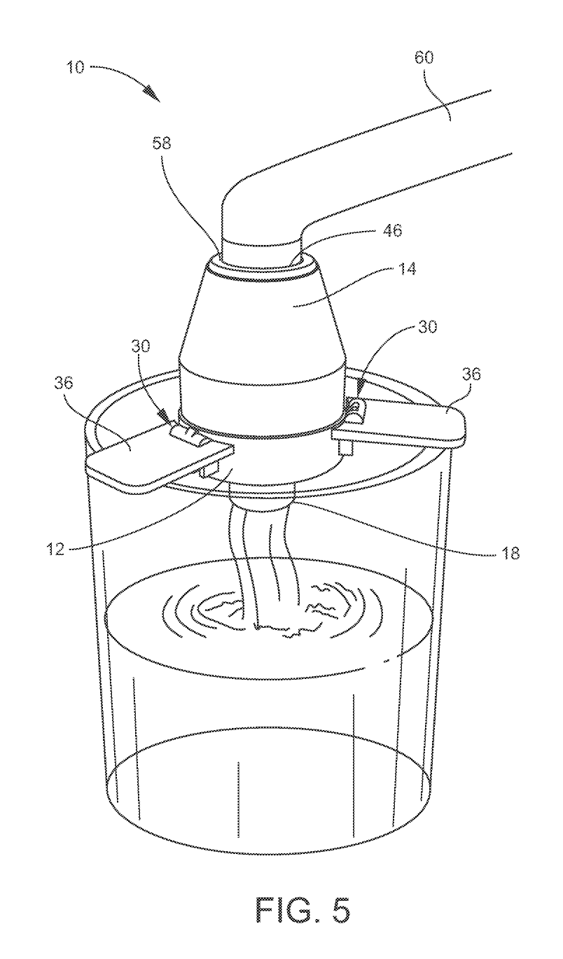

The wings 36 may have many different forms and aesthetic appeal. The wings 36, as illustrated, are generally square shaped, but may be in any number of different shapes, including generally rectangular. The purpose of the wing 36 is to engage the rim of a container and suspend the water container filler device 10 “over top” the container, as illustrated in FIG. 5. Over top is meant to describe the suspension of the water container filler device 10 over a container for allowing water to flow through the opening 46 and into the container.

The top portion 14 is generally conically shaped to prevent splash back and contains an upper portion and lower portion. The lower portion of the top portion 14, positioned in close proximity to the bottom portion 12, has a diameter very close to the diameter of the bottom portion 12, thus allowing the bottom portion 12 and the top portion 14 to be selectively secured to one another. As show, the lower portion of the top portion 14 has a diameter slightly larger than the diameter of the annular ring 22 of the bottom portion 12 for allowing the annular ring 22 to be received within the lower portion of the top portion 14 in a selectively secured arrangement.

The upper portion of the top portion 14 is generally conical and contains the opening 46 for allowing water to enter the device 10. In other words, the upper portion increases in diameter as it progresses from the opening 46 to the lower portion. This arrangement prevents the splash back from water entering the device 10, or water from encountering resistance within the device 10 and attempting to exit the opening 46. The lower portion may be generally annular and contain internal threads with an interior rim 48 within the cavity 16.

An optional filter media or filter member 50 may be disposed within the cavity 16 formed by the bottom portion 12 and top portion 14. One form of optional filter media or filter member 50 may be filter paper that is impregnated with carbon media. The filter paper is thick enough to allow proper filtering, but has a thickness that allows the filter paper to easily fit within the cavity. Alternatively, a cylindrically shaped carbon block may be used or the like. However, any filter media or filter member 50 known to one of ordinary skill in the art may be utilized.

An optional filter retainer 52 is disposed within the cavity 16. The filter retainer 52 may serve to retain the filter media or filter member 50 in place within the cavity 16 while allowing water to flow through the filter media or filter member 50. As illustrated, the filter retainer 52 contains a plurality of holes that allow the water to pass through the filter retainer 52 and contact the filter media or filter member 50. The filter retainer 52 may contain at least one post 54 that is received within a bore 56 positioned within the cavity 16 and on the interior wall of the lower portion of the top portion 14 for engaging the filter retainer 52 to the top portion 14. As illustrated, the interior wall of the lower portion of the top portion 14 contains four bores 56 and the top side of the filter retainer 52 comprises four posts 54, wherein the four posts 54 are received within the four bores 56 for engaging the filter retainer 52 to the top portion in a selectively secured arrangement. In an alternative embodiment as illustrated in FIG. 6, ribs 66 are disposed within the cavity 16 and positioned on the interior surface of the body in close proximity to the opening 46. These ribs 66 are designed to provide a stop for the filter retainer 52 and preventing movement of the filter retainer 52 within the cavity 16.

A mouth piece 58 is received within the opening 46. The mouth piece 58 may be composed of a soft material for fitting on or around an aerator of a faucet 60, as illustrated in FIG. 5. The mouth piece 58 is designed to engage and fit snugly around an aerator on a faucet 60 without damaging the faucet 60 or allowing water to seep from the seal created by the mouth piece when engaged to the aerator on the faucet 60. The mouth piece 58 is retained within the opening 46 by friction fit or the like. An optional top 62 may be releasably disposed within the mouth piece 58 or optionally the opening 46.

In another alternative embodiment, the water container filler device 10 is one uniform piece. In other words, the bottom portion 12 and the top portion 14 are not separate pieces that can be separated from one another. The primary purpose of having a bottom portion 12 and a top portion 14 that are selectively secured to one another is to allow the easy replacement of the optional filter media or filter member 50. In this alternative embodiment that incorporates a non-separable, uniform piece, the optional filter media or filter member 50 is not replaced or non-existent and the water container filler device 10 is thrown away once the filter media has reached its rated capacity.

The water container filler device 10 is designed to be portable. Preferably, the water container filler device 10 may be enclosed within a case and carried around in a user's pocket, purse, bag, etc. prior to use. During use and as illustrated in FIG. 5, the device 10 is placed over top a container with the wing 36 engaged to the upper rim of the container. The mouth piece 58 is engaged to the aerator of a faucet 60, allowing water to enter the opening 46 in the top portion 14 so that the water can proceed through the opening 46 and into the cavity 16 of the device 10. As the water proceeds through the cavity 16, the water may pass through the optional filter media or filter member 50, thus filtering the water. The water then proceeds through the outlet 18 of the bottom portion 12 and into the drinking glass, water bottle, or the like.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A water container filler device, comprising:
a body;
an opening within the body;
a cavity within the body;
at least one wing that is engaged to the body; and
an outlet.

2. The water container filler device of claim 1, wherein the body includes a top portion and a bottom portion that are selectively secured to one another.

3. The water container filler device of claim 1, further comprising a filter retainer for receiving a filter media.

4. The water container filler device of claim 1, further comprising a mouth piece engaged to the opening in the body.

5. The water container filler device of claim 1, wherein the inlet and outlet are aligned in the axial direction.

6. The water container filler device of claim 1, further comprising at least two wings pivotally engaged to the body.

7. The water container filler device of claim 1, further comprising at least three wings pivotally engaged to the body.

8. The water container filler device of claim 1, further comprising a notch on the underside of the at least one wing and a catch positioned on an external side of the body for receiving the notch.

9. A water container filler, comprising:
a body that includes a top portion and a bottom portion that are selectively secured to one another;
an opening within the body that is designed to allow water to flow into the body through the inlet;
a cavity within the body;
at least one hinge engaged to an external side of the body;
at least one wing pivotally engaged to the at least one hinge; and
an outlet for allowing the water to flow out of the body.

10. The water container filler of claim 9, further comprising a filter member disposed within the cavity.

11. The water container filler of claim 9, further comprising a filter retainer for retaining a filter media within the cavity.

12. The water container filler of claim 9, wherein the opening and outlet are aligned in the axial direction.

13. The water container filler of claim 9, further comprising a mouth piece disposed within the inlet for engaging an aerator on a faucet.

14. The water container filler device of claim 1, further comprising at least three wings pivotally engaged to the body.

15. The water container filler device of claim 1, further comprising a notch on the underside of the at least one wing and a catch positioned on an external side of the body for receiving the notch.

16. A method for filtering water, comprising:
providing a device comprising body, an opening within the body, a cavity within the body, at least one wing that is engaged to the body, and an outlet for allowing the water to flow out of the body;
placing the device over a container; and
allowing water to enter the opening and flow through the device and into the container.

17. The method for filtering water of claim 16, further comprising a filter member disposed within a cavity of the body.

18. The method for filtering water of claim 16, further comprising placing the at least one wing on a top portion of the container.

19. The method for filtering water of claim 16, further comprising providing for three wings pivotally engaged to an exterior surface of the body.

20. The method for filtering water of claim 16, further comprising providing a mouthpiece disposed within the inlet.
